(19) United States
(12) Patent Application Publication
(10) Pub. No.: US 2023/0100672 A1
(43) Pub. Date: Mar. 30, 2023

(54) MANAGEMENT SYSTEM AND MANAGEMENT METHOD OF WIRELESS DEVICES

(71) Applicant: Realtek Singapore Private Limited, Singapore (SG)

(72) Inventors: KUNMING YANG, Singapore (SG); Zhenwu Zhang, Singapore (SG)

(21) Appl. No.: 17/485,681

(22) Filed: Sep. 27, 2021

(51) Int. Cl. G06F 16/955; G06F 16/957; H04W 76/14

(52) U.S. Cl. CPC G06F 16/9558; G06F 16/9574; H04W 76/14

(57) ABSTRACT

A management system includes a plurality of wireless devices, a database and a server. Each of wireless devices includes pairing information. The database is configured to store a plurality of user information and the pairing information of the wireless devices, and each of user information is corresponding to the pairing information of at least one wireless device. The server is configured to provide a login webpage to receive input data, and to determine whether the input data corresponds to one of the plurality of user information. When determining the input data corresponds to one of the plurality of user information, the server obtains the corresponding pairing information from the database according to the input data, and provides a control webpage corresponding to the input data based on the obtained pairing data. The control page is used to control the at least one wireless device of the obtained pairing information.

### BACKGROUND

### Technical Field

The present disclosure relates to wireless devices, and in particular relates to management system and management method of wireless devices.

### Related Art

In recent years, the concept of IOT (Internet of Things) has emerged, and related applications have developed vigorously. In tradition, a user needs to download an application dedicated to control wireless devices at first, and the user only can control the wireless devices after completing an identity verification process through the application.

However, downloading and installing the dedicated application require some tedious operations, and the user needs to spend time waiting for the download and the install. Furthermore, it is not friendly for the elderly to download and install the dedicated application. Moreover, each time the user opens the application, the user needs to perform the identity verification process again, which is very tedious and time-consuming.

### SUMMARY

The present application provides a management system. In an embodiment, the management system includes a plurality of wireless devices, a database and a server. Each of wireless devices includes pairing information. The database is configured to store a plurality of user information and the paring information of the plurality of wireless devices, and each the user information is corresponding to the paring information of at least one wireless device. The server is configured to provide a login webpage to receive input data, and to determine whether the input data corresponds to one of the plurality of user information. When determining that the input data corresponds to one of the plurality of user information, the server obtains the corresponding paring information from the database according to the input data, and provides a control webpage corresponding to the input data according to the obtained paring information. The control webpage is used to control the at least one wireless device of the obtained paring information.

The present application provides a method for managing a plurality of wireless devices. In an embodiment, the method includes: providing a login webpage to receive an input data; determining whether the input data corresponds to one of a plurality of user information, wherein each of the plurality of user information is corresponding to paring information of at least one of the plurality of wireless devices; when determining that the input data corresponds to one of the plurality of user information, obtaining the corresponding paring information according to the input data; and providing a control webpage corresponding to the input data according to the obtained paring information, wherein the control webpage is used to control at least one the wireless devices of the obtained paring information.

### BRIEF DESCRIPTION OF THE DRAWINGS

The disclosure will become more fully understood from the detailed description given herein below for illustration only, and thus not limitative of the disclosure, wherein:

FIG. 1 illustrates a schematic diagram of an embodiment of a management system of wireless devices;

FIG. 2 illustrates a schematic flowchart of an embodiment of a management method for managing wireless devices;

FIG. 3 illustrates a schematic diagram of an embodiment of a management system of wireless devices;

FIG. 4 illustrates a schematic flowchart of an embodiment of a management method for managing wireless devices; and

FIG. 5 illustrates a schematic flowchart of an embodiment of step S07.

### DETAILED DESCRIPTION

In order to make the above objects, features and advantages of the embodiments of the present invention easier to understand, a detailed description is given in the following embodiments with reference to the accompanying drawings.

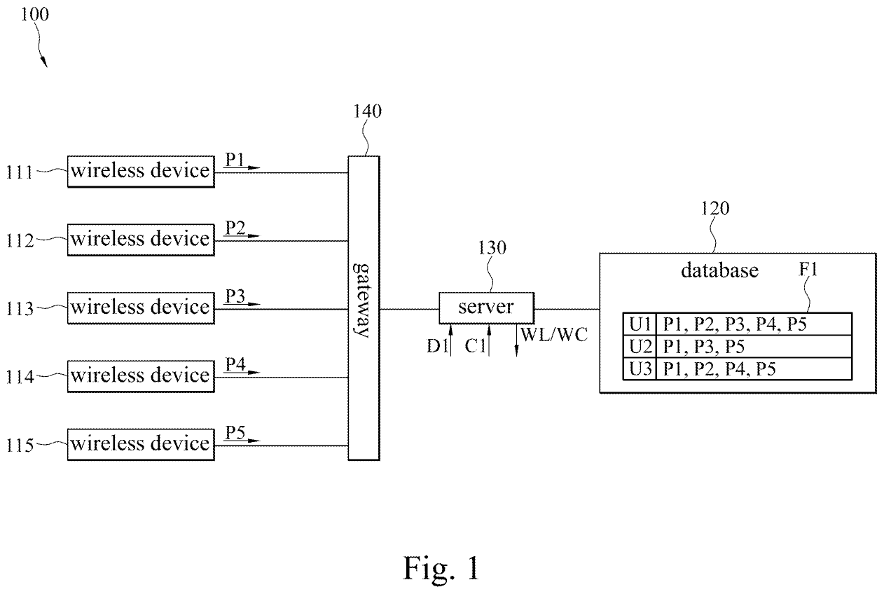

FIG. 1 illustrates a schematic diagram of an embodiment of a management system of wireless devices. Please refer to FIG. 1. A management system 100 can be configured to determine whether a user is an authorized user. When determining that the user is the authorized user, the management system 100 generates and provides, according to the user's authority, a control webpage WC for the user to operate, wherein the control webpage WC including a controllable list including at least one of wireless devices (e.g., IoT devices) and their control options. In this way, the user has no need to touch the entity of the wireless devices but can still control the wireless devices through the control webpage WC provided by the management system 100.

In some implementations, the management system of IOT 100 may be applied but not limited to accommodations such as service apartments, hotels, motels and villas, and the user may be a lodger of the aforementioned accommodations.

The management system 100 can include a plurality of wireless devices 111-115, a database 120 and a server 130. It should be noted that the present application uses five wireless devices 111-115 as an example for the convenience of explanation, but the number of the wireless devices is not limited to this value and could be any value.

Each of wireless devices 111-115 can be respectively connected to the server 130 in communication. In some embodiments, each of wireless devices 111-115 may be respectively connected to the server 130 in communication through wireless manner. In some implementations, the wireless manner may include but not limited to Bluetooth communication, Wi-Fi communication, infrared communication, radio frequency communication, WiMAX (Worldwide Interoperability for Microwave Access) and the combination thereof.

In some embodiments, the management system 100 can further include a gateway 140. The gateway 140 is communicatively connected to the wireless devices 111-115 and server 130, and the wireless devices 111-115 and the serve 130 communicate via the gateway 140.

Each wireless device 111-115 includes paring information P1-P5. Each wireless device 111-115 can be respectively paired with the server 130 with its paring information P1-P5, to establish a communicative connection between the wireless devices 111-115 and the server 130.

In some implementations, each of wireless devices 111-115 may be an IOT device, such as air conditioner, light, fan, television, door or refrigerator. However, the present application is not limited thereto. Each of wireless devices 111-115 could be any device that can be communicatively connected to the server 130 for contactless control. Furthermore, each of paring information P1-P5 could be a device identification code of one of wireless devices 111-115.

The database 120 is communicatively connected to the server 130. The database 120 is configured to store a plurality of user information U1-U3 and the paring information P1-P5 of the plurality of wireless devices 111-115. Herein, each of user information U1-U3 can correspond to the paring information P1-P5 of at least one of wireless devices 111-115. For example, the user information U1 may correspond to the paring information P1-P5 of the wireless devices 111-115; the user information U2 may correspond to the paring information P1 of wireless device 111, the paring information P3 of wireless device 113 and the paring information P5 of wireless device 115; and the user information U3 may correspond to the paring information P1 of wireless device 111, the paring information P2 of wireless device 112, the paring information P4 of wireless device 114 and the paring information P5 of wireless device 115. It should be noted that the present application uses three user information as an example for the convenience of explanation, but the number of the user information is not limited to this value and could be any value.

In some implementations, each of user information U1-U3 may be but not limited to user account or PIN (Personal Identification Number) code. The correspondence between the plurality of user information U1-U3 and the paring information P1-P5 of the wireless devices 111-115 may be stored in the database 120 in the form of table F1. Furthermore, the database 120 may be a cloud database, a local network database, or a storage disposed in the server 130 (for example but not limited to a magnetic disk or hard disk).

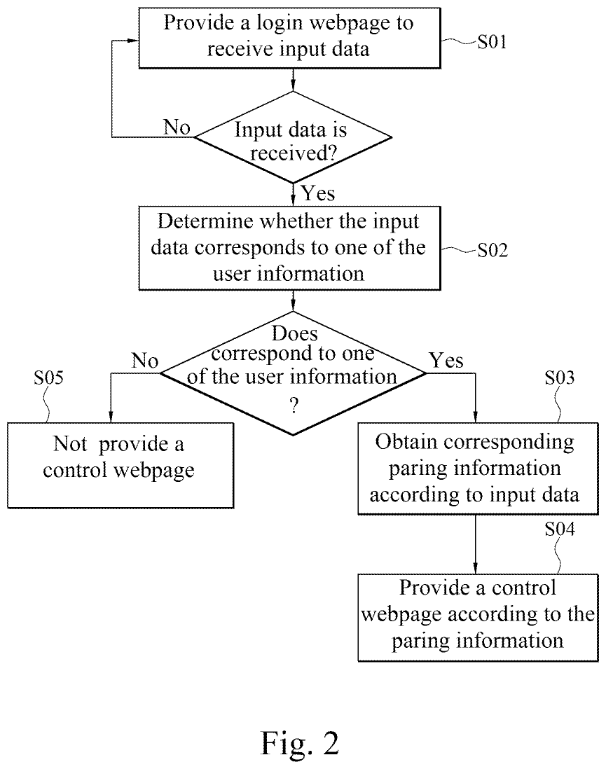

The management system 100 of any embodiment can execute the management method for managing wireless devices of any embodiment in the present application. FIG. 2 illustrates a schematic flowchart of an embodiment of a management method for managing wireless devices. Please refer to FIG. 1 and FIG. 2. In an embodiment of management method, a server 130 of the management system 100 can provide a login webpage WL including at least one input field (step S01) for a user to enter input data D1 through the at least one input field of the login webpage WL.

In some embodiments, the input data D1 entered by the user (a lodger) may be user information provided to the lodger by the accommodation operator after the lodger has checked in.

After receiving the input data D1 entered by the user, the server 130 compares the input data D1 with the plurality of user information U1-U3 to determine whether the input data D1 corresponds to one of the plurality of user information U1-U3, and the server 130 can confirm whether the user is an authorized user based on the comparison result (step S02).

When the server 130 determines that the input data D1 corresponds to one of the plurality of user information U1-U3, it represents that the user is an authorized user. At this time, the server 130 obtains corresponding paring information from the database 120 according to the input data D1 (step S03), and provides a control webpage WC corresponding to the input data D1 according to the obtained paring information to the user (step S04). In this way, the user can remotely control at least one of IOT devices 111-115 through the control options on the control webpage WC, thereby avoiding physical contact control.

For example, assuming that the server 130 determines the input data D1 is corresponded to the user information U2. At this time, the server 130 can obtain the corresponding paring information P1, P3 and P5 of the user information U2 form the table F1 in the database 120, and provides a control webpage WC corresponding to the input data D1 according to the obtained paring information P1, P3 and P5 to the user. Wherein, the control webpage WC provided by the server 130 at this time includes the wireless devices 111, 113 and 115 and the control options of the wireless devices 111, 113 and 115, such that the user can remotely control the wireless devices 111, 113 and 115 through the control webpage WC. By way of illustration, the user can generate, through the control webpage WC, a control command for controlling the wireless device 113 to the server 130. After receiving the control command, the server 130 can forward the control command to the wireless device 113 through the gateway 140, or firstly generate a control instruction according to the control command and then transmit the control instruction to the wireless device 113 through the gateway 140, such that the wireless device 113 performs corresponding action according to the control command or the control instruction.

In any embodiment of the management method, when the server 130 determines that the input data D1 does not correspond to any one of the plurality of user information U1-U3, it represents that the user is not an authorized user. At this time, the server 130 will not provide control webpage WC to the user (step S05). As a result, the user is unable to remotely control the wireless devices 111-115 by operating the control webpage WC.

In some embodiments, when the user checks out, the accommodation operator can enter a delete command C1 corresponding to the input data D1 to the server 130 to delete the user information obtained by the user during check-in. Therefore, in any embodiment of the management method, the server 130 will delete the user information corresponding to the input data D1, e.g. deletes the user information U2 from the table F1 in the database 120 after receiving the delete command C1 corresponding to the input data D1 (step S06). Herein, the table F1 after deleting the user information U2 only includes the correspondence between the user information U1 and U3 and the paring information P1-P5. As a result, the user with user information U2 is unable to remotely control any wireless devices 111-115 anymore.

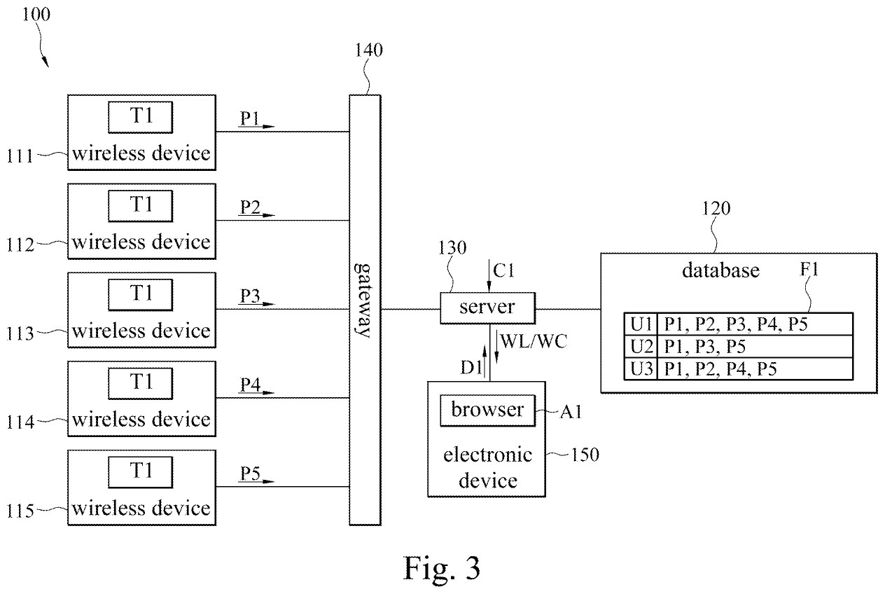

FIG. 3 illustrates a schematic diagram of an embodiment of a management system. Please refer to FIG. 3. In some embodiments, the management system 100 can further include an electronic device 150, and the electronic device 150 can be communicatively connected to the server 130 in a wireless manner or a wired manner.

In some implementations, the electronic device 150 may be but not limited to smart phone, tablet computer, PDA (personal digital assistant), laptop or other devices with network communication function. The wireless manner may include but not limited to Wi-Fi communication, WiMAX, third-generation mobile communication, fourth-generation mobile communication, fifth-generation mobile communication and the combination thereof. Furthermore, the wired manner may include but not limited to Ethernet, optical fiber networks, ASDL and the combination thereof.

In some embodiments, the electronic device 150 includes a browser A1, and the browser A1 can be configured to open and display webpage.

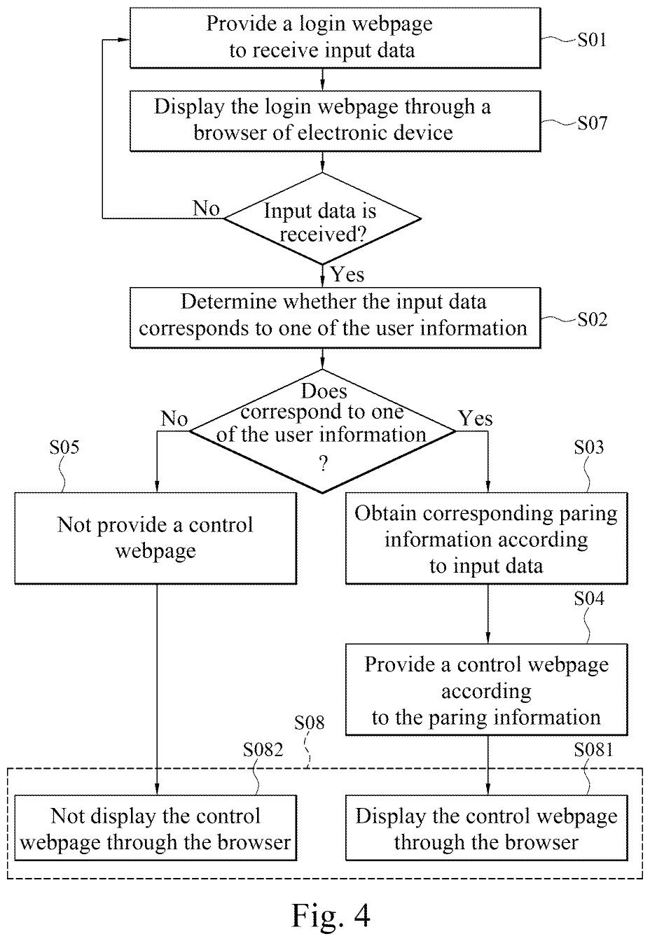

FIG. 4 illustrates a schematic flowchart of an embodiment of a management method for managing wireless devices. Please refer to FIG. 3 and FIG. 4. In any embodiment of management method, after the server 130 provides the login webpage WL, the management system 100 can further display the login webpage WL to the user through the browser A1 of the electronic device 150 (step S07), thereby the user can enter the input data D1 through the login webpage WL displayed by the browser A1 of the electronic device 150.

Furthermore, the management system 100 can further selectively display the control webpage WC to the user through the browser A1 of the electronic device 150 (step S08). In an embodiment of step S08, after the server 130 determines that the user is an authorized user in the step S02 and then executes the step S03 and the step S04 in sequence, the server 130 provides a control webpage WC, and the electronic device 150 displays the control webpage WC to the user through the browser A1 (step S081), thereby the user can remotely control at least one of IOT devices 111-115 through the control options on the control webpage WC. While, after the server 130 determines that the user is not an authorized user in the step S02 and then executes the step S05, the server 130 does not provide a control webpage WC, and the electronic device 150 will not display the control webpage WC to the user through the browser A1 (step S082).

In some embodiments, the user can open the login webpage WL by entering the link of the login webpage WL in the browser A1. However, the present application is not limited thereto. In other embodiments, the user can open the login webpage WL on the browser A1 by scanning a machine-readable tag T1 through the electronic device 150.

In some embodiments, the management system 100 further includes at least one machine-readable tag T1, each machine-readable tag T1 includes the link of the login webpage WL, and the at least one machine-readable tag T1 can be disposed on the wireless devices 111-115. Herein, at least one of the wireless devices 111-115 is disposed with a machine-readable tag T1. For example, a single machine-readable tag T1 is disposed on the wireless device 111, or three machine-readable tags T1 in total are respectively disposed on the wireless devices 111, 113 and 115. However, the present application is not limited thereto. In other embodiments, each of the wireless devices 111-115 is disposed with a machine-readable tag T1 as shown in FIG. 3, thereby the user can scan the machine-readable tag T1 through the electronic device 150 anywhere.

In some implementations, the machine-readable tag T1 may be but not limited to a two-dimensional barcode or a three-dimensional barcode. The link of the login webpage WL may be a URL (Uniform Resource Locator). Furthermore, through the cooperation of decoding program and the camera module, the electronic device 150 can parse the link of the login webpage WL by capturing (or scanning) the machine-readable tag T1.

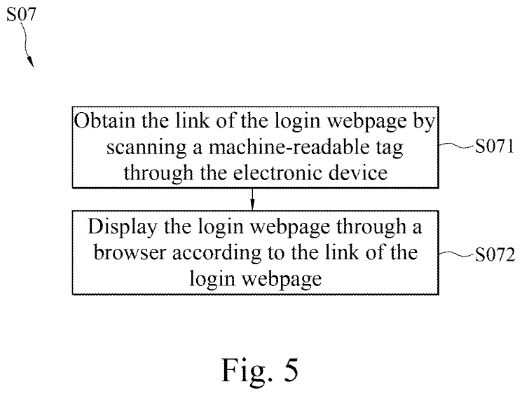

FIG. 5 illustrates a schematic flowchart of an embodiment of step S07. Please refer from FIG. 3 to FIG. 5. In an embodiment of step S07, the electronic device 150 can obtain the link of the login webpage WL by scanning any machine-readable tag T1 (step S071), and displays the login webpage WL according to the link through the browser A1 (step S072).

In any embodiment of the management method, after the user enters the input data D1 into the input field of the login webpage WL, the management system 100 can further automatically generate a history data according to the input data D1 through the browser A1 of the electronic device 150. Furthermore, when the user reopens the login webpage WL through the browser A1 and the step S07 is executed again, the electronic device 150 can automatically use the history data as the input data D1 and bring the history data into the input field of the login webpage WL. As a result, the user has no need to perform the tedious enter actions again, and the login operation can be completed more quickly.

In some implementations, the history data may be automatically generated by a Cookie function of the browser A1.

In some embodiments, the browser A1 may be preloaded in the electronic device 150. For example, the browser A1 could be installed in the electronic device 150 before the electronic device 150 is shipped. By way of illustration, when the electronic device 150 is iPhone of Apple Inc., the browser A1 is Safari. In this way, instead of downloading and installing the application dedicated to control wireless devices at first, the user can directly open the control webpage WC through the preloaded browser A1, thereby eliminating some tedious operations and the time took to download and install the application.

In sum, the embodiments of the present application provide a management system and a management method of wireless devices, which provide a login webpage to receive input data, obtain corresponding paring information when determining that the input data corresponds to one of the user information, and provide a control webpage according to the obtained paring information. Therefore, instead of downloading and installing the dedicated application, the user can remotely control at least one of the wireless devices through the control webpage, thereby eliminating some tedious operations and the time took to download and install the application. Furthermore, the management system and the management method of wireless devices of the present application can automatically use history data as the input data into the login webpage when the user opens the login webpage again, such that the user has no need to perform the tedious enter actions again, and the login operation can be completed more quickly.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A management system, comprising:
a plurality of wireless devices, wherein each of the plurality of wireless devices comprise pairing information;
a database, configured to store a plurality of user information and the pairing information of the plurality of wireless devices, wherein the database stores corresponding pairing information for one or more of the wireless devices with each user information; and
a server, configured to:
provide a login web page to an electronic device;
receive input data for a user login from the electronic device;
determine whether the received login input data corresponds to one of the plurality of user information stored in the database;
only in response to a determination that the received data corresponds to one of the plurality of user information stored in the database:
obtain from the database the pairing information corresponding to the user information for the user logged in from the electronic device;
provide to the electronic device an identification of wireless devices to which the logged in user has the ability to control via the electronic device; and
control corresponding wireless devices in response to control input information provided by the user through the electronic device; and
in response to the server receiving a delete or check-out command, inhibiting further control of the corresponding wireless device from being controlled by control input information provided by the user through the electronic device.

2. The management system of claim 1, further comprising:
at least one machine-readable tag, disposed on the plurality of wireless devices, and each the machine-readable tag comprises a link of the login webpage.

3. The management system of claim 1, further comprising:
an electronic device, comprising a browser, and the electronic device displays the control webpage and selectively displays the control webpage corresponding to the input data through the browser.

4. The management system of claim 3, wherein the browser is preloaded in the electronic device.

5. The management system of claim 3, further comprising:
at least one machine-readable tag, disposed on the plurality of wireless devices, each the machine-readable tag comprises a link of the login webpage, and wherein the electronic device is configured to scan the machine-readable tag to obtain the link of the login webpage.

6. The management system of claim 3, wherein the electronic device further generates a history data according to the input data, and automatically uses the history data as the input data into the login webpage when again entering the login webpage through the browser.

7. The management system of claim 6, wherein the history data is generated by a Cookie function of the browser.

8. The management system of claim 1, wherein the control webpage is not used to control at least one the wireless devices of the obtained pairing information when determining that the input data does not correspond to any one of the plurality user information.

9. A method for managing a plurality of wireless devices, comprising:
providing a database configured to store a plurality of user information and the pairing information of the plurality of wireless devices, wherein the database stores corresponding pairing information for one or more of the wireless devices with each user information
providing a login webpage to an electronic device to receive an input data for a user login from the electronic device;
determining whether the login input data corresponds to one of a plurality of user information stored in the database, wherein each of the plurality of user information is corresponding to pairing information of at least one of the plurality of wireless devices;
only in response to a determination that the received data corresponds to one of the plurality of user information stored in the database:
obtaining from the database the pairing information corresponding to the user information for the user logged in from the electronic device;
providing to the electronic device an identification of wireless devices to which the logged in user has the ability to control via the electronic device; and
controlling corresponding wireless devices in response to control input information provided by the user through the electronic device; and
in response to the server receiving a delete or check-out command, inhibiting further control of the corresponding wireless device from being controlled by control input information provided by the user through the electronic device.

10. The method of claim 9, further comprising:
displaying the login webpage through a browser of an electronic device; and
selectively displaying the control webpage corresponding to the input data through the browser of the electronic device.

11. The method of claim 10, wherein the browser is preloaded in the electronic device.

12. The method of claim 10, wherein at least one machine-readable tag is disposed on the plurality of wireless devices, each the machine-readable tag comprises a link of the login webpage, and wherein the step of displaying the login webpage through the browser of the electronic device comprises:
scanning, by the electronic device, the machine-readable tag to obtain the link of the login webpage; and
displaying the login webpage according to the link of the login webpage.

13. The method of claim 10, further comprising:
generating a history data according to the input data; and
using the history data as the input data into the login webpage when entering the login webpage again.

14. The method of claim 13, wherein the history data is automatically generated by a Cookie function of the browser.

15. The method of claim 9, further comprising:
when determining that that the input data does not corresponds to any one of the plurality of user information, the control webpage is not used to control at least one the wireless devices of the obtained pairing information.
